(19) United States
(12) Patent Application Publication
(10) Pub. No.: US 2006/0132454 A1
(43) Pub. Date: Jun. 22, 2006

(54) Systems and methods for high resolution optical touch position systems

(76) Inventors: Deng-Peng Chen, Singapore (SG); Wee-Sin Tan, Singapore (SG); Kai-Koon Lee, Singapore (SG); Chee-Heng Wong, Singapore (SG); Soon-Lee Tan, Singapore (SG); Masatoshi Yamai, Tokyo (JP); Pak-Hong Yee, Singapore (SG); Rani Saravanan, Singapore (SG); Seok Peng Chan, Singapore (SG)

Correspondence Address: AVAGO TECHNOLOGIES, LTD., P.O. BOX 1920, DENVER, CO, 80201-1920, US

(21) Appl. No.: 11/013,556

(22) Filed: Dec. 16, 2004

(51) Int. Cl. G09G 5/00

(52) U.S. Cl. 345/173

(57) ABSTRACT

In one embodiment, a touch detection system and method is achieved having high resolution by forming an integrated array of alternating emitters and detectors. Using integration techniques, the detectors can be made much larger than the emitters while the gaps between the emitters and detectors are maintained relatively small. Thus, high resolution is achieved without dramatically increasing the number of emitter/detector pairs. In one embodiment each array is positioned on an edge of a display such that the emitter of one array is lined up (on axis with) a detector of an opposing display. In one embodiment, the touch detection system and method operates to detect the amplitude of signals arriving from opposing arrays so as to precisely determine the location of a touched position. Off-axis scanning can be employed to increase sensitivity.

### TECHNICAL FIELD

This disclosure is related to optical touch position systems and more particularly to such systems using interleaved emitters and detectors and using full amplitude signal detection and processing.

### BACKGROUND

Infrared optical touch panels can be found in a variety of systems, most notably on 10″ to 15″ LCD display systems such as ATM terminals, vending machines, and kiosk terminals. By surrounding the LCD with infrared emitters paired with corresponding detectors across the LCD display, the touch panels are able to respond to contact with the screen. Such a response is accomplished by scanning each of the infrared emitters sequentially to determine whether the infrared signal received by the corresponding detector has been “blocked”. When a blocked signal is found, a “touch” is sensed and the position of the touch is calculated based on the “blocked” detector.

For large LCD display systems, such as the ones discussed above, it is easy to place numerous emitter/detector pairs around the system as the size of the emitters and detectors are not a major constraint on such relatively large display systems. The numerous pairings produce a relatively sensitive screen and enables the user to make contact in many areas of the screen.

However, coupled with the growth in the market for portable devices is the demand for infrared displays on these devices. It has become increasingly marketable to include highly-sensitive infrared displays on cellular phones, personal digital assistants (PDAs), calculators, and the like. By including infrared displays on these systems, manufacturers are able to replace traditional key pads and further decrease the size of these devices.

As a result of the decrease in size of these portable devices, it has become a major technical challenge to implement highly-accurate infrared optical touch panels in such a limited space. As the space available to mount these infrared systems onto the portable devices has decreased considerably, manufacturers desire to keep the width and thickness of the infrared system on these devices minimal. To accomplish this goal, the size of the emitter/detector pairs must be designed in very low profile to fit the dimensions of these compact systems.

The use of infrared panels on portable devices is further constrained by the need for accuracy and sensitivity. Thus, such devices must be able to support use of a stylus having a relatively fine point as well as handwriting recognition. This in turn increases the need for a high-resolution, high-sensitivity display. Accordingly, such a system must either include a large number of emitter/detector pairs, thus increasing the overall size and bulk of the device, or employ an algorithm and alternate design for the emitter/detector pairing to produce a high-resolution, highly-sensitive infrared panel that is relatively compact in size.

### BRIEF SUMMARY

A touch detection system and method is accomplished by surrounding an LCD display with integrated arrays of alternating emitters and detectors. By integrating the arrays into one unit, the size of the detectors can be much greater than that of the emitters and the space between each emitter and its adjacent detector can be reduced to a relatively small amount. In one embodiment, a touch detection system and method is achieved having high resolution by forming an integrated array of alternating emitters and detectors. Using integration techniques, the detectors can be made much larger than the emitters while the gaps between the emitters and detectors are maintained relatively small. Thus, high resolution is achieved without dramatically increasing the number of emitter/detector pairs. In one embodiment each array is positioned on an edge of a display such that the emitter of one array is lined up (on axis with) a detector of an opposing display. In one embodiment, the touch detection system and method operates to detect the amplitude of signals arriving from opposing arrays so as to precisely determine the location of a touched position. Off-axis scanning can be employed to increase sensitivity. By lining up emitters on one edge of the display with a corresponding detector on an array across the display, a greater percentage of the display screen is covered by infrared signals, thus increasing the sensitivity and resolution of the touch detection system.

In one embodiment a change in amplitude of the optic signal is detected yielding, a greater degree of accuracy can be achieved when calculating the position of an object in contact with the display screen.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### DESCRIPTION OF THE DRAWINGS

FIGS. 1 and 2 show prior art touch screen system;

FIG. 3 shows one embodiment of a high resolution touch screen;

FIG. 4A illustrates how coordinates of a “touch” can be determined for a relatively large stylus;

FIG. 4B illustrates how coordinates of a “touch” can be determined for a small stylus; and

FIG. 5 illustrates the logic controlling one embodiment of the system.

### DETAILED DESCRIPTION

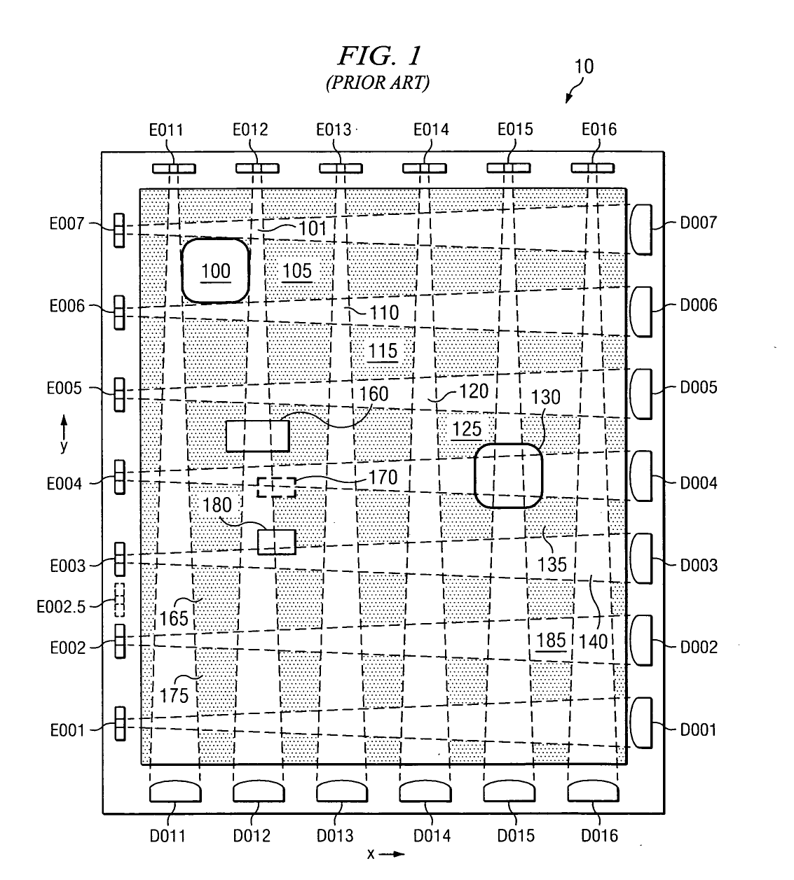

FIG. 1 depicts one prior art optical touch system. On the vertical axis, emitters are placed on the left side of display 10, while corresponding detectors are placed on the opposite edge of the display, thus forming emitter/detector pairings 001-007 along the vertical (y) axis. Note that each pair (such as pair 001) includes an emitter (such as emitter E001) and a detector (such as detector D001). The same pairings occur on the horizontal axis of display 10, with emitters placed at the top of display 10 and corresponding detectors located at the bottom of the display, forming emitter/detector pairings 011-016 along the horizontal (x) axis. Under the prior art, when contact 130 is sensed, the system scans the y-coordinate by activating emitter/detector pairs 001-007 sequentially. Thus, beginning with emitter/detector pair E001 and D001, the system determines whether the infrared signal between the emitter and corresponding detector has been blocked. This process occurs until the system activates emitter E003 and detector D003, and recognizes that the signal between emitter E003 and detector D003 has been interrupted. Thus, the y-coordinate of contact 130 is known. The system then scans the x-axis by sequentially activating emitter/detector pairs 011-016 to determine where the infrared signal has been blocked. Upon activating emitter E015, the system recognizes that the signal to detector D015 has been blocked, and the x-coordinate of contact 130 is thus known. As both the horizontal and vertical axis have been scanned, the position of contact 130 is now known. In actual practice, several beams would be interrupted (unless the stylus was very small) and the position would be determined by averaging the x position and then the y position.

The conventional touch screen system works relatively well when large objects make contact with a particular position on the screen and completely block the infrared signals produced by two intersecting emitter/detector pairings. However, a number of problems arise under the prior art. As depicted in FIG. 1, the resolution of the display screen is limited by the density of the emitter/detector pairs. Since the emitted infrared signal from an emitter is conical in shape it tends to “fan” out as it traverses the panel and thus a signal from one detector would fall upon not only the diode directly opposite, but on adjacent diodes as well. This will cause cross-talk and by enabling the emitter/diode pairs sequentially such cross-talk is reduced. Because the signal is a conical beam the area that can be detected is limited by the width of the detecting diode. This, as will be noted below, allows “holes” in the coverage for touches having small size and results in areas of display 10 that are not covered by an infrared signal. For example, if contact occurs precisely at position 101, 110, 120, 130, or 140, blockage of intersecting signals is recognized and the exact location of contact can be determined. However, if contact occurs at positions 105, 115, 125, or 135, upon sequential activation of the emitter/detector pairs on both the vertical and horizontal axis, the signal is not blocked, and contact is not registered. Using the conventional method, contact is detected on less than 50% of the screen and blind spots, such as blind spot 100, result. This will cause serious problems when the stylus size is small because the stylus cannot block any beam if the stylus is touching areas such as 100, 105, 115, 125 or 135.

FIG. 1 also depicts one attempt by the prior art to increase the density of infrared signals as shown, additional emitters are positioned between the existing emitters E001 to E007. However, simply inserting additional emitters, such as additional emitter E002.5 does not work because there is not sufficient room to insert matching diodes between diode D002 and D003. In order to make room for additional detectors (thereby increasing sensitivity), the size of each detector would have to be made smaller with the result that the sensitivity of the detectors actually decreases (less volume upon which light can fall) on thus the power of each emitter must be increased to maintain sensitivity.

Other problems also arise when an object only partially blocks an infrared signal. For example, contact-area 160, while interrupting x-axis emitter/detector pair 012 fails to interrupt any cross-signal produced by any emitter/detector pair on the y-axis, and contact-area 170 only partially interrupts a signal between emitter/detector pairs 004 and 012. In the case where only one signal is partially or fully blocked, only one coordinate can be obtained and the system must employ alternative methods to determine the second coordinate of the object. Off-axis sweeping has been suggested as a possible remedy to this problem. However, if off-axis sweeping is to be done, the system would require higher speed processing capabilities and more complicated algorithms for mapping from a non-uniform (cross-axis) grid to a uniform one.

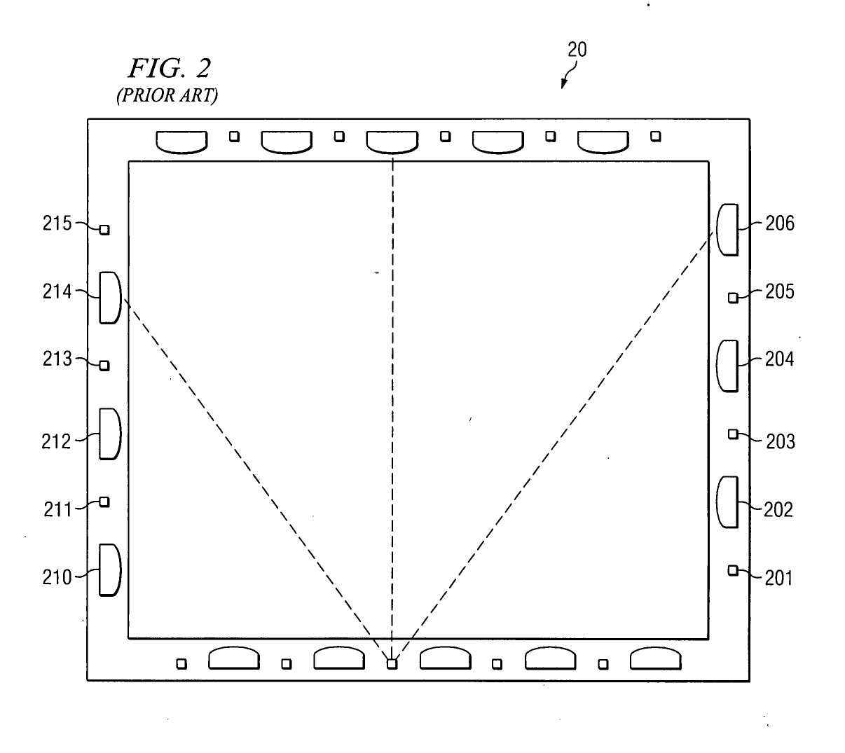

As depicted in FIG. 2, attempts have been made to alternate emitters and detectors around a display such as display 20, in an effort to ameliorate the density issues noted with respect to FIG. 1. In this configuration, emitter 201 is situated adjacent to detector 202, which is situated adjacent emitter 203, etc. On the opposite side of display 20, detector 210 receives a signal from emitter 201, emitter 211 produces a signal received by detector 202, etc. Although an improvement over the conventional touch-screen method, this alternating scheme still results in less than 50% of display 20 being covered by infrared signals.

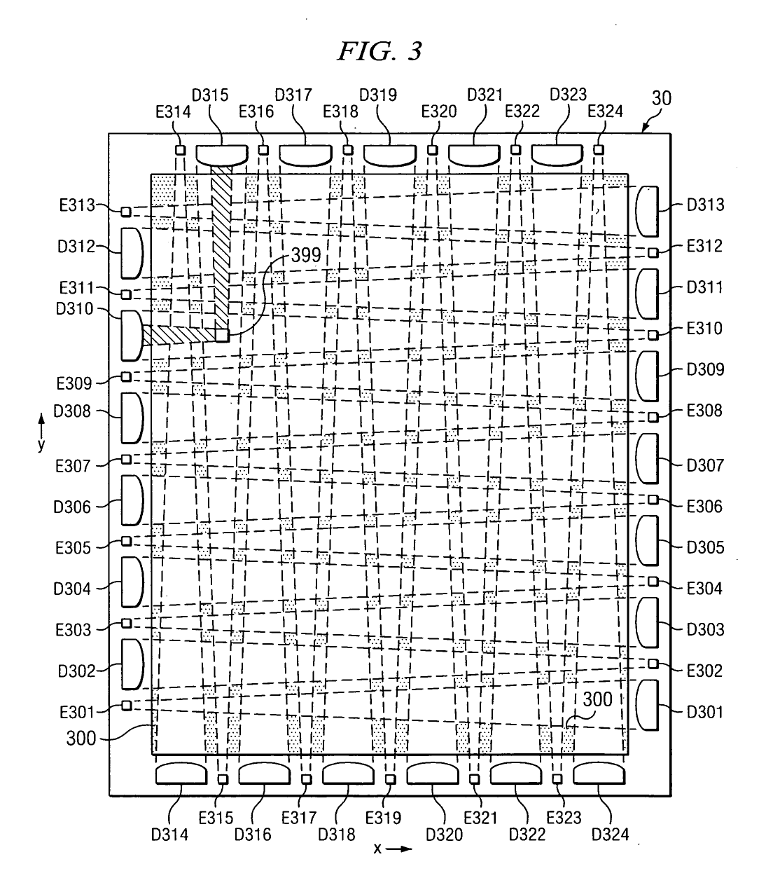

FIG. 3 depicts one embodiment of a high resolution touch screen. Along each horizontal and vertical axis, emitters and diodes are alternated and integrated into arrays. In these arrays, the emitter size is fairly small and the detector diameter is fairly large. By increasing the proportional size of a detector relative to its corresponding emitter, the sensitivity of the sensor is maintained and thus less power consumption is required by the emitter. Additionally, the gaps between emitters and detectors are kept as small as possible (on the order of 1 mm, thus increasing the number of emitters and detectors that can be inserted around the display system in a given area a typical detector would be at least 3 times the size of an emitter. As a result of the interleaving configuration with such a small gap size and emitter/detector ratio to length, the overall sensitivity of the system to contact is increased due to greater signal coverage.

By constructing these arrays using integrated circuit technology, the arrays can be positioned around the four edges of display 30 and can have a height of 0.4 mm with a width of 0.4 mm. This results in an emitter on one-axis aligned with a detector on the same axis across display 30. For example, the array comprising the left y-axis is arranged such that emitter E301 is placed directly adjacent to detector D302. Located directly across display 30 on the right y-axis are corresponding detector D301 and emitter E302. The same pairing occurs on the horizontal axis—emitter E314 at the top display 30 is paired with detector D314 at the bottom of display 30 and emitter D324 at the top display 30 is paired with detector D324 at the bottom of display 30.

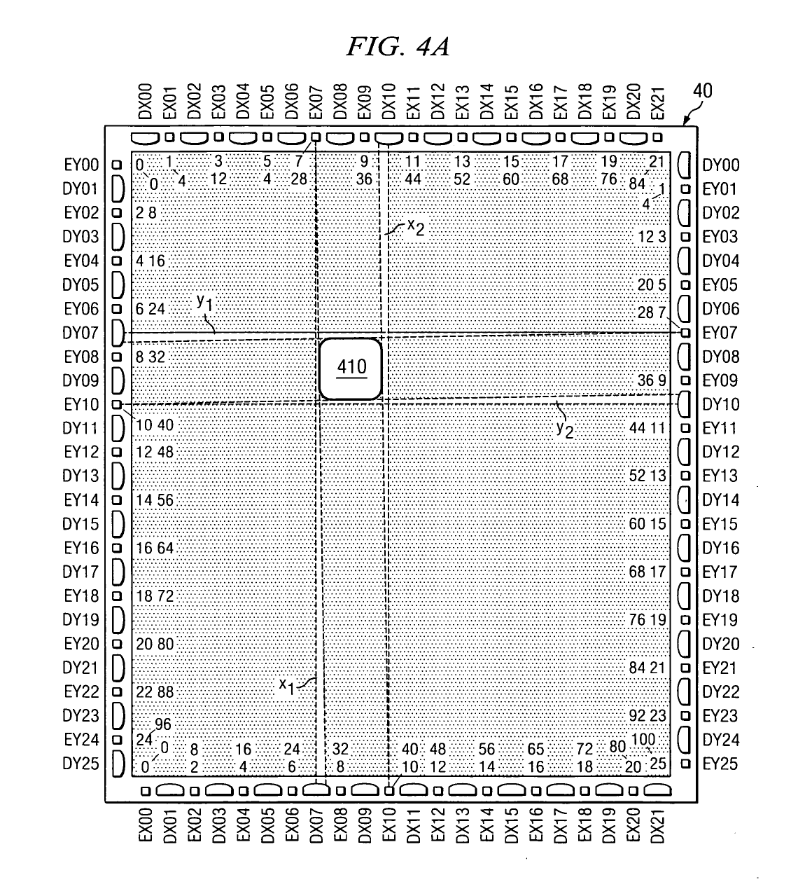

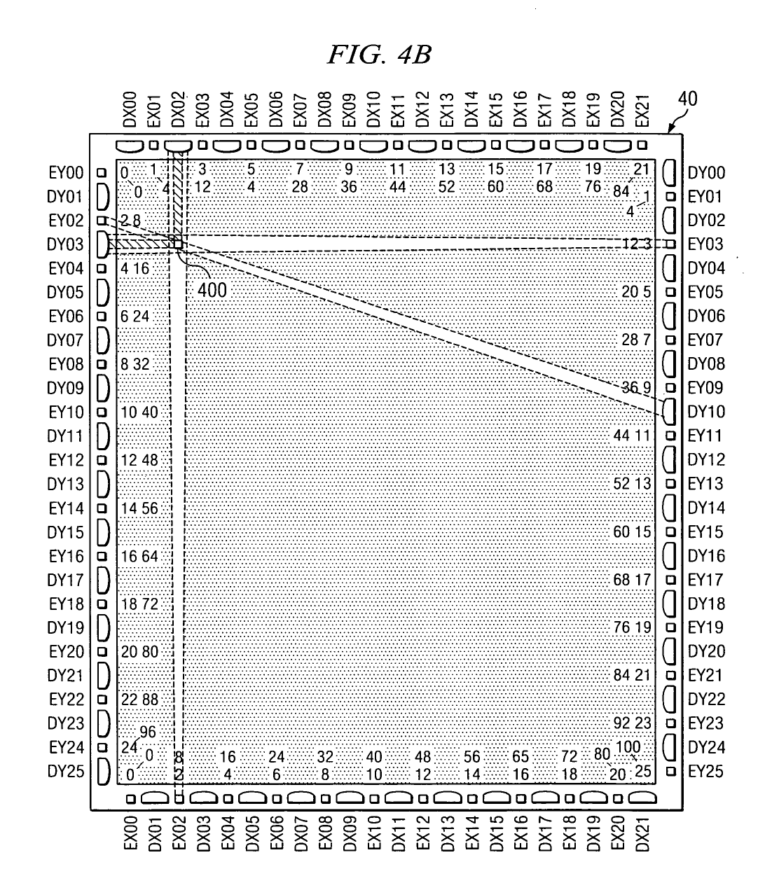

As shown in FIG. 4A for a relatively large stylus, when an object 410 comes into contact with display 40, the system performs on-axis x and y direction sweeping to provide the coarse position (Xi, Yi) and size information of the stylus. This coarse information is (X1, X2; Y1, Y2), where X1 and X2 (X2>=X1) are the starting and ending coarse coordinates in the X direction, while Y1 and Y2 (Y2>=Y1) are the starting and ending coarse coordinates in the y-direction. The detected amplitudes at X1, X2, Y1, Y2 is more than or equal to zero (partially or completely blocked), while the amplitudes of those between them are zero (completely blocked).

As depicted in FIG. 4A, the emitter and detector pairs on the x axis are labeled EX00, DX00, EX01, DX01 to EX13, DX13 and on the Y axis, EY00, DY00 to EY21, DY21. The coarse X coordinates are defined from 0 to 13 Y from 0 to 21. Note that any number of pairs can be used on the X or Y axis. The panel is divided so that the fine x coordinates are from 0 to 50 and the fine y coordinates are from 0 to 96. For different panel sizes and the ratio of emitter to detector pairs and gap size, the fine coordinate dividing may be different. Slight approximation is needed for establishing the coordinate dividing.

The controller will activate the emitter/detector pairs simultaneously in any sequence. One example would be to scan X00, X02, X04, . . . X20, X01, X03, . . . X21, Y00, Y02, Y04, . . . Y24, Y01, Y03, . . . Y25 sequentially. Another example would be to scan X00, X01, X02, . . . X21, Y00, Y01, Y02, . . . Y25 sequentially. The coarse coordinates and the detected signal amplitudes are recorded for those blocked (completely or partially) pairs. The starting and ending of the x coarse coordinates are denoted as X1 and X2, and those of y coarse coordinates Y1 and Y2. The signals amplitudes of these four detectors are AX1, AX2, AY1, AY2. For example, if stylus position 410 is shown as in FIG. 4A, X1=7, X2=10, Y1=7, Y2=10, AX1=10%, AX2=60%, AY1=70%, AY2=70%. Ne Nd and Ng are denoted as the number of fine grids of the emitter, detector and gap. Nx and Ny are denoted as the maximum of coarse X and Y coordinate. In the example, Ne=1, Nd=5, Ng=1, NX=13, NY=21. AX and AY are denoted as the amplitude of each detector without any portion of the signal being blocked. For simplicity of explanation, assume AX and AY to be 1. The above information will be used to calculate the fine starting and ending x and y coordinates following the algorithm shown below. The method utilizes similitude triangular relationships between the un-blocked detector width (proportional) to the signal amplitude and the blocked beam width in the stylus position. The geometric gravity center of the stylus expressed in coarse coordinate (X1+X2)/2, (Y1+Y2)/2 and NX, NY will be involved in the calculation.

The following is one embodiment of an

```
//algorithm to map the starting and ending detector's coarse coordinate
(X1, X2, Y1, Y2) + amplitude (AX1, AX2, AY1, AY2) to fine coordinate
(xx1, xx2, yy1, yy2).
//determine xx1
    if (X1%2==1) { //if starting X coordiante is on top, which is the case
    here
        xx1=int (X1*(Ne+Nd+Ng*2)/2.0−(1.0/2.0−
  AX1/AX)*Nd*(Y1+Y2)/2.0/NY);
    }
    else { // if starting X coordinate is on bottom
        xx1=int (X1*(Ne+Nd+Ng*2)/2.0−(1.0/2.0−AX1/AX)*Nd*(1.0−
  (Y1+Y2)/2.0/NY));
    }
    //determine xx2
    if (X2%2==1) { //if ending X coordinate is on top
        xx2=int (X2*(Ne+Nd+Ng*2)/2.0+(1.0/2.0−
  AX2/AX)*Nd*(Y1+Y2)/2.0/NY);
    }
    else { //if ending X coordinate is on bottom, which is the case
    here
        xx2= int (X2*(Ne+Nd+Ng*2)/2.0+(1.0/2.0−AX2/AX)*Nd*(1.0−
  (Y1+Y2)/2.0/NY));
    }
    //determine yy1
    if (Y1%2==1) { //if starting Y coordinate is in right, which is the case
    here
        yy1=int (Y1*(Ne+Nd+Ng*2)/2.0−(1.0/2.0−AY1/AY)*Nd*(1.0−
  (X1+X2)/2.0/NX));
    }
    else { //if starting Y coordinate is in left
        yy1=int (Y1*(Ne+Nd+Ng*2)/2.0−(1.0/2.0−
  AY1/AY)*Nd*(X1+X2)/2.0/NX);
    }
    //determine yy2
    if (Y2%2==1) { //if ending Y coordinate is in right
        yy2=int (Y2*(Ne+Nd+Ng*2)/2.0+(1.0/2.0−AY2/AY)*Nd*(1.0−
  (X1+X2)/2.0/NX));
    }
    else { //if ending Y coordinate is in left, which is the case here
        yy2=int (Y2*(Ne+Nd+Ng*2)/2.0+(1.0/2.0−
  AY2/AY)*Nd*(X1+X2)/2.0/NX);
    }
```

As shown in FIG. 4B, when the stylus, such as stylus 400, is small it might be located within a beam. In this case, X1=X2 and/or Y1=Y2. In this case, off-axis sweeping is needed to acquire the fine coordinates. For example, as shown in FIG. 4B, for the initial scanning we obtain the coarse coordinates Y1=Y2=3. By activating the nearby LED E402 and then sequentially activating the detectors on the opposite side, the blocked area in the right side frame can be determined. Again using similitude relationship between the two triangles, we can obtain accurate information of the y coordinates. Note that the selection of activated LED is based on the position (coarse coordinates) of the stylus. For example, if the stylus is located in the first quadrant of the panel, then the LED to determine the fine y coordinate should be the one on the left and directly above the coarse coordinate; while the LED to determine the fine x coordinate should be on the top and directly to the left of the coarse coordinate. The principle is to “project” the small value of width to the frame so as to “amplify” it.

Upon calculation of the coordinates of a touched position, the system is then able to utilize the precise coordinates of contact to accomplish a myriad of activities, including, but not limited to, handwriting analysis, invocation of various applications, name-recognition dialing, memo functions, and changes in user preferences.

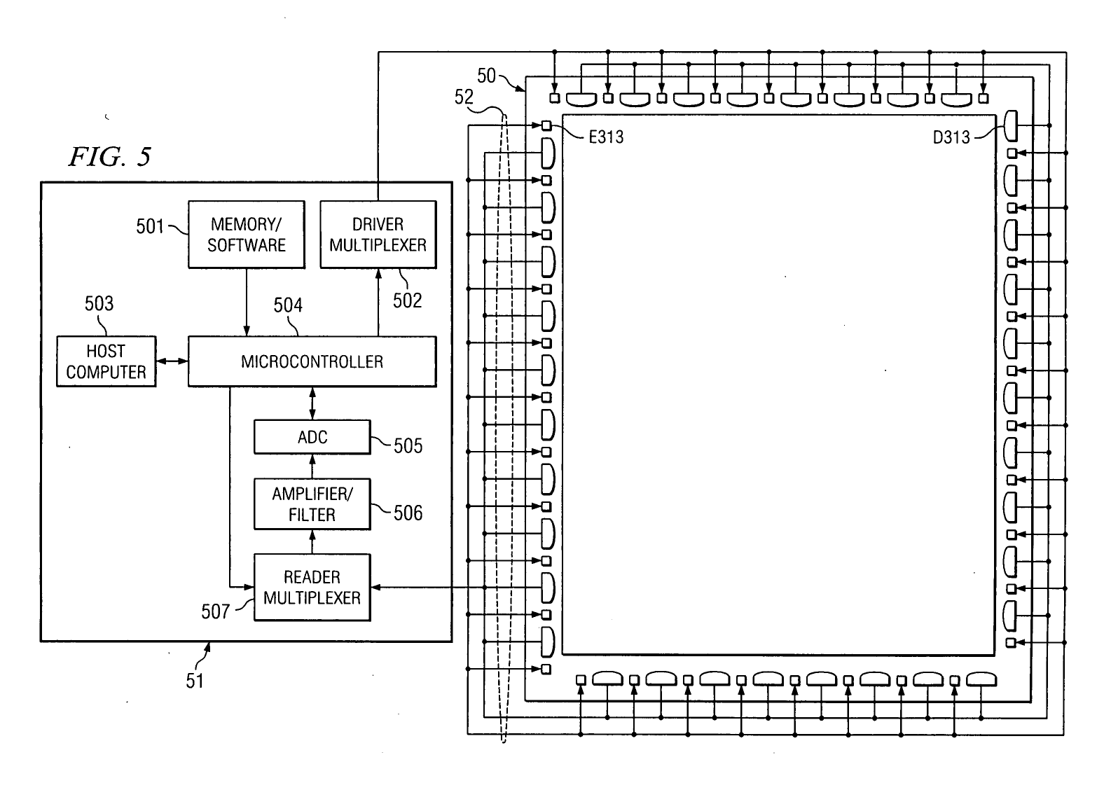

FIG. 5 illustrates the logic controlling one embodiment of the system. Display 50 is connected to controller 51 by cable 52, which typically would be a wireline connection, such as a flexible PCB, but could, if desired, be wireless. Controller 51 would typically also be formed as part of display 50, perhaps on the back thereof, or in a separate control unit attached nearby. Within controller 51 reader multiplexer 507 is syncronized with driver multiplexer 502 so that driver multiplexer turns on an emitter, such as emitter E313, and multiplexer 507 turns on diode D313, which is matched to emitter E313. For off-axis sweeping, one emitter is enabled and the photodiodes on the opposite side of frame are also enabled sequentially, because they are sharing the same amplifier/filter/ADC circuits. For on-axis screening, all other diodes are switched to ground to avoid cross-talk. This then allows for sequential enablement of the diode-emitter pairs around periphery of the device for on-axis screening. For off-axis screening, one emitter is enabled all of the diodes along the opposite edge are enabled in sequence. This allows for detection of a small stylus. Reader multiplexer 507 is connected to amplifier/filter 506, which is in turn connected to Analog-to-Digital Converter (ADC) 505. The ADC 505, memory/software 501, and Driver/Multiplexer 502 and Reader Multiplexer 507 all feed into Microcontroller 504. Software in memory 501 can control microcontroller 504, if desired, note that control 51 can, if desired, be one or more ASICS. In one embodiment, microcontroller 504 is connected to a host computer, such as computer 503, which can be in the same physical location, as would occur for a cellular phone or PDA, or can be remote and accessed wirelessly for other types of touch screens.

Use of an array of alternating emitters and detectors on integrated circuits solves a number of problems present in the prior art. First, there are fewer “blind spots” on the display screen. By alternating emitters and diodes, decreasing the gaps between the two, and increasing the size of the detectors, the current system is able to significantly increase the density of the infrared signals over the prior art without significantly increasing the emitter/diode pairs. This increase in density allows for use of a smaller stylus and better coordinate mapping. Second, instead of determining the coordinates of a touch by detecting whether a beam has been blocked, the present system arguments its detection by also determining coordinates by determining a change in amplitude of the infrared signal and also by off-axis screening.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, compositions of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A touch position device comprising:
at least two opposing arrays of interleaved emitters and detectors, each said array being integrated into a single unit.

2. The device of claim 1 wherein each gap between an emitter and a next adjacent detector is less than 1 mm.

3. The device of claim 1 wherein the detector size is relatively large as compared to the emitter size.

4. The device of claim 3 wherein the ratio of detector to emitter is at least 3 to 1.

5. The device of claim 1 further comprising:
means for determining the position of an object imposed between said opposing interleaved emitters and detectors.

6. The device of claim 5 wherein said opposing arrays are arranged so that an emitter from one array is paired with a detector in said opposing array and wherein said determining means comprises:
means for sequentially enabling each emitter of said emitter/detector pairing and simultaneously reading the output signal level from each detector of said emitter/detector pair so as to detect at least an edge of said pairing object.

7. The device of claim 6 wherein said determining means further comprises:
means for determining the boundaries of said object by repeatedly enabling certain of said emitter/detector pairings.

8. The device of claim 7 wherein last-mentioned said determining means comprises:
means for determining both coarse and fine coordinates of said object.

9. A method for determining a touched position within a bounded area, said method comprising:
positioning an integrated array of interleaved emitters and detectors on opposing edges of said bounded area, and
detecting by at least one detector on one array a signal sent from at least one emitter on said opposing array.

10. The method of claim 9 wherein said detecting comprises:
at least one signal amplitude from said detector.

11. The method of claim 9 wherein said detecting is based on an interference signal, said interference signal resulting from signals sent from a plurality of emitters.

12. The method of claim 10 where at least one of said interference signals is sent from an emitter on the same integrated array as a detecting detector.

13. The method of claim 9 wherein said detecting comprises:
summing amplitude outputs from a plurality of detectors.

14. The method of claim 9 further comprising:
determining a position of a touch within said bounded area based, at least in part, by said detecting.

15. The method of claim 14 wherein said determining uses both on-axis and off-axis scanning.

16. The method of claim 15 wherein said off-axis scanning is used when the boundaries of a touch are within the boundaries established by a single emitter.

17. The method of claim 14 wherein said determining uses a combination of coarse and fine coordinate calculations.

18. A touch position sensitive device comprising:
a surface bounded by at least two integrated arrays of opposing alternating emitters and detectors; and
means for determining a temporarily touched position with respect to said bounded surface.

19. The device of claim 18 wherein said determining means comprises:
an algorithm for using both coarse and fine x/y coordinates to calculate said position.

20. The device of claim 19 wherein said algorithm utilizes signal strength from said detectors in said position calculation.

21. The device of claim 18 wherein each gap between an emitter and a next adjacent detector is less than 1 mm.

22. The device of claim 18 wherein the detector size is relatively large as compared to the emitter size.

23. A hand held device comprising:
a plurality of integrated alternating signal emitters and signal detectors arranged to form arrays, said arrays positioned to define a display area; and
a processor operable from signals emitted from at least one of said signal emitters and by at least one of said detectors for determining the relative position within said display area of a temporary intrusion between at least one signal emitter and at least on signal detector.

24. The device of claim 23 wherein said intrusion is caused by a stylus.

25. The device of claim 23 wherein said detected signals are signals from a plurality of said emitters.

26. The device of claim 23 wherein said processor determining is, at least in part, based upon the output amplitude of said at least one detector.

27. An optical touch panel system comprising:
a plurality of integrated arrays of interleaved emitters and detectors;
a display area bounded by a plurality of said integrated arrays; and
a processor for enabling the determination of an object's position when said object contacts said display area.

28. The system of claim 27 wherein the size of said detectors is relatively large as compared to the size of said emitters.

29. The system of claim 27 wherein said processor detects optic signals emitted from a plurality of emitters and wherein said processor interprets changes in amplitude of said optic signals.

30. A method for determining a touched position within a bounded area, comprising:
positioning integrated arrays of interleaved emitters and detectors on opposing edges of said bounded area;
determining change in amplitude of a signal between at least one emitter and its corresponding detector;
performing on-axis sweeping of the bounded area to determine a quadrant in which said signal's amplitude is altered;
determining a size of said object altering said amplitude of said signal;
determining a nearest emitter to said altered signal; and
activating said nearest emitter and opposing detectors to determine a relative position of said object.

31. A device comprising:
an interleaved set of emitters and detectors integrated onto a single substrate, said emitters operable for providing optic signals and said detectors operable for detecting optic signals.

32. The device of claim 31 wherein said optic signals are infrared signals.

33. The device of claim 31 wherein the size of said detector is relatively large compared to the size of said emitter.

34. The device of claim 31 wherein the gap between each emitter and detector is less than 1 mm.
